(19) United States
(12) Patent Application Publication
(10) Pub. No.: US 2015/0302747 A1
(43) Pub. Date: Oct. 22, 2015

(54) TRAFFIC SIGNS RECOGNITION APPARATUS AND METHOD OF OUTPUTING SPEED LIMIT USING THE SAME

(71) Applicant: MANDO CORPORATION, Pyeongtaek-si (KR)

(72) Inventor: Dai Chang RO, Seongnam-si (KR)

(21) Appl. No.: 14/688,438

(22) Filed: Apr. 16, 2015

(30) Foreign Application Priority Data
Apr. 22, 2014 (KR) 10-2014-0048270

(51) Int. Cl. G08G 1/0967

(52) U.S. Cl. CPC G08G 1/096783

(57) ABSTRACT

The present invention relates to a traffic sign recognition device configured to be capable of combining road information received from a navigation terminal with road information acquired through a camera so as to recognize and output a speed limit of a traffic sign to be suitable for a fluid road environment and travel environment on a road, and a method of outputting a speed limit using the traffic sign recognition device.

### CROSS-REFERENCE TO RELATED APPLICATION

This application claims priority from and the benefit under 35 U.S.C. §119(a) of Korean Patent Application No. 10-2014-0048270, filed on Apr. 22, 2014, which is hereby incorporated by reference for all purposes as if fully set forth herein.

### BACKGROUND OF THE INVENTION

1. Field of the Invention

The present invention relates to a traffic sign recognition device and a method of outputting a speed limit using the traffic sign recognition device. More particularly, the present invention relates to a traffic sign recognition device configured to be capable of combining road information received from a navigation terminal with road information acquired through a camera so as to recognize and output a speed limit of a traffic sign to be suitable for a fluid road environment and travel environment on a road, and a method of outputting a speed limit using the traffic sign recognition device.

2. Description of the Prior Art

A Traffic Sign Recognition (TSR) device refers to a system capable of preventing a traffic accident due to speeding by recognizing a general or electronic traffic sign through a front camera during the operation of a vehicle, and displaying corresponding information on a cluster to provide speed limit information of a road, on which the vehicle is traveling, and a warning to the driver.

Such a traffic sign recognition device is hardly damaged as compared with a lane in view of a position thereof on the road and thus maintains a relatively normal state even in a lapse of a time. However, in a case of an own vehicle, a malfunction may occur in the traffic sign recognition device so that even a traffic sign irrelevant to a direction may be changed. or in an environment where a road attribute is changed, the newest information cannot be delivered to the driver.

Situations, in which the malfunction may occur, include the following cases: the traffic sign recognition device recognizes a speed limit sign of a road irrelevant to the traveling direction of the own vehicle at a place where a road, such as an advancing road or a high-level load, is branched; the traffic sign recognition device recognizes a speed limit sign of a road irrelevant to the traveling direction of the own vehicle at an intersection, that is, when the speed limit signs of a straight-travel lane, a left-turn lane, and right-turn lane are different from each other, the traffic sign recognition device recognizes a speed limit sign irrelevant to the traveling direction of the own vehicle; the traffic sign recognition device does not recognize a speed limit sign of a new road in a change section between an expressway and a national highway; and the traffic sign recognition device does not recognize a new speed limit sign after having recognized a speed limit release sign in a construction section, for example.

Accordingly, what is requested is an improved traffic sign recognition device capable of recognizing a traffic sign suitable for a traveling environment of the own vehicle by reflecting information as to whether a road is branched, road attribute information, and position information, and providing speed limit information of the road to give a warning.

### PRIOR ART DOCUMENT

### Patent Document

Patent Document 1: Korean Patent Laid-Open Publication No. 2010-4022 published on Jan. 12, 2010 and entitled “Navigation Device, System, and Method Using Road Sign.”

### SUMMARY OF THE INVENTION

An object of the present invention is to provide a traffic sign recognition device configured to be capable of combining road information received from a navigation terminal with road information acquired through a camera so as to recognize a speed limit of a traffic sign to be suitable for a fluid road environment and travel environment and output the speed limit, and a method of outputting a speed limit using the traffic sign recognition device.

In order to achieve the objects described above, according to one embodiment of the present invention, there is provided a traffic sign recognition device. The traffic sign recognition device includes: a navigation terminal configured to store a road attribute; and an electronic control unit configured to recognize a speed limit indicated on a traffic sign positioned on a travel road, on which a vehicle is traveling, through a camera and control outputting of the speed limit according to the road attribute.

According to another embodiment of the present invention, there is provided a traffic sign recognition device that acquires and outputs a speed limit of a traffic sign on a road through a camera. The traffic sign recognition device includes: navigation terminal configured to generate and display a travel route when a starting place and a destination are designated; and an electronic control unit configured to fuse road information on the generated travel route received from the navigation terminal while a vehicle is traveling on the generated travel route and road information acquired through the camera, to determine a travel road based on a road attribute and a travel route included in the road information of the road, on which the vehicle is traveling, and to recognize and output a speed limit of the determined travel road from the combined road information.

The road attribute may include a branch road, a road at an intersection, a change road from an expressway to a national highway, a change road from a national highway to an expressway, or a road in a construction section.

When the road attribute included in the information received from the navigation terminal is a branch road, the electronic control unit may defer outputting of a speed limit recognized through a traffic sign until the vehicle reaches a junction, determines the travel road of the vehicle, which is branched from the junction, using GPS information of the vehicle, and outputs a speed limit of a traffic sign positioned on the determined travel road.

When the road attribute included in the information received from the navigation terminal is a road at an intersection, the electronic control unit may determine whether a travel road, on which the vehicle is to travel, is a straight-advancing road, a left turning road, or a right turning road according to a heading angle of the vehicle, and when the travel road is determined, the electronic control unit may output a speed limit of a traffic sign positioned on the determined travel road.

When the road attribute included in the information received from the navigation terminal is a change road, the electronic control unit may delete a speed limit of a traffic sign recognized on the traffic road, on which the vehicle has traveled, and output a speed limit of a traffic sign recognized on a changed travel load, on which the vehicle is traveling.

When the road attribute included in the information received from the navigation terminal is a road in a construction section, the electronic control unit recognizes a speed limit release sign of the road in the construction section, and then recognizes and outputs a speed limit of a travel road, on which the vehicle is traveling.

According to still another embodiment of the present invention, there is provided a method of outputting a speed limit using a traffic sign recognition device which acquires and outputs a speed limit of a traffic sign on a road through a camera. The method includes: generating and displaying a travel route by designating a starting place and a destination; combining road information received from a navigation terminal during travel on the generated travel route and road information acquired through the camera; and determining a travel road based on a road attribute and the travel route included in the road information received from the navigation terminal, and recognizing and outputting a speed limit of a traffic sign positioned on the determined travel road from the combined road information.

When the road attribute received from the navigation terminal is a branch road, the outputting of a speed limit recognized through a traffic sign may be deferred until the vehicle reaches a junction, the travel road of the vehicle, which is branched from the junction, may be determined using GPS information of the vehicle, and a speed limit of a traffic sign positioned on the determined travel road may be output.

When the road attribute received from the navigation terminal is a road at an intersection, it may be determined whether a travel road, on which the vehicle is to travel, is a straight-advancing road, a left turning road, or a right turning road according to a heading angle of the vehicle, and when the travel road is determined, a speed limit of a traffic sign positioned on the determined travel road may be output.

When the road attribute received from the navigation terminal is a change road, a speed limit of a traffic sign recognized on the traffic road, on which the vehicle has traveled, may be deleted and a speed limit of a traffic sign recognized on a changed travel load, on which the vehicle is traveling, may be output.

When the road attribute received from the navigation terminal is a road in a construction section, a speed limit release sign of the road in the construction section is recognized, and then, a speed limit of a travel road, on which a vehicle is traveling, is recognized and output.

According to the embodiments of the present invention, the road information received from the navigation terminal and the road information acquired through the camera so that a speed limit of a traffic sign can be recognized and output to be suitable for a fluid road environment and a travel environment on a fluid road.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram for describing a traffic sign recognition device according to an embodiment of the present invention;

FIG. 2 is a block diagram for describing an electronic control unit illustrated in FIG. 1;

FIG. 3 is an operation flowchart for describing a method of outputting a speed limit using a traffic sign recognition device according to an embodiment of the present invention; and

FIGS. 4 to 7 are illustrative views illustrating various examples of recognizing a speed limit of a traffic sign based on a road attribute and a travel route, and outputting the speed limit.

### DETAILED DESCRIPTION OF THE EXEMPLARY EMBODIMENTS

A traffic sign recognition device according to an embodiment of the present invention may include a navigation terminal that stores a road attribute, and an electronic control unit that recognizes a speed limit indicated on a traffic sign through a camera, and controls outputting of the speed limit according to the road attribute.

Here, the description, “controls outputting of the speed limit,” may mean that the speed limit may be displayed or may not be displayed.

In addition, the electronic control unit may acquire various information items from the navigation terminal, and control outputting of the speed limit recognized through the camera, using the information items.

According to this embodiment, the traffic sign recognition device is capable of delivering a correct speed limit value to a driver even in a state where the navigation terminal has not updated a speed limit value of a changed traffic sign. In addition, even in a situation or section where a correct speed limit cannot be displayed only based on the recognition of a traffic sign through the camera, the traffic sign recognition device is capable of displaying a correct speed limit using the information of the navigation terminal.

Hereinafter, embodiments of the present invention will be described in detail with reference to the accompanying drawings.

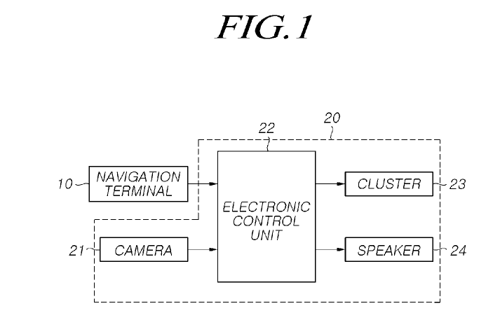

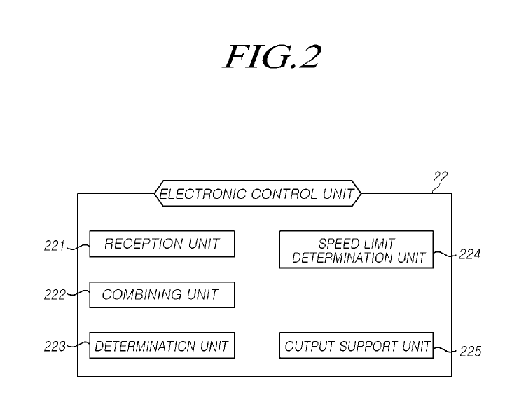

FIG. 1 illustrates a block diagram for describing a traffic sign recognition device according to an embodiment of the present invention, and FIG. 2 illustrates a block diagram for describing an electronic control unit illustrated in FIG. 1.

Referring to FIG. 1, a traffic sign recognition device 20 according to an embodiment of the present invention outputs a speed limit of a traffic sign suitable for a road environment of a travel road or a travel environment using road information received from navigation terminal 10. Here, the traffic sign includes a road sign on a road, and a sign that indicates a speed limit at the top end of a support fixedly installed at a side of a road.

The traffic sign recognition device 20 includes a camera 21 configured to photograph an environment of a road on which an own vehicle is traveling or an environment in front of the own vehicle that is traveling, and an electronic control unit 22 configured to perform a control such that road information acquired from the camera 21 is combined with road information received from the navigation terminal 10 and a speed limit of a traffic sign is displayed on a cluster 23 or output through a speaker 24.

In particular, the electronic control unit 22 recognizes in advance whether a travel road is a branch road based on road information of the travel road which is received from the navigation terminal 10 during the travel along a travel route generated by designating a starting place and a destination or an arrival place through the navigation terminal 10, defers outputting of the speed limit of a traffic sign recognized until arrival at a point where the travel road is branched, and outputs the speed limit of a speed limit of a travel road when the travel road on which the vehicle shall travel is finally determined at a junction using GPS information of the vehicle. In addition, in a case where the travel road is at an intersection, the electronic control unit 22 determines whether to travel straight, whether to turn left, or whether to turn right according to a heading angle of the vehicle, and outputs a speed limit of a traffic sign positioned on the travel road in the determined direction.

The above-mentioned heading angle of the vehicle may be determined based on road information measured through the camera 21. In addition, a separate sensor may be added to measure the heading angle of the vehicle and the electronic control unit 22 may receive the measured heading angle.

When the travel road is in a change section from a highway to a national road or in a change section from a national road to a highway, the electronic control unit 22 deletes the speed limit prior to a change road and newly recognizes a speed limit of a traffic sign on the change road to output the speed limit of the newly recognized traffic sign.

In addition, when the travel road is in a construction section, the electronic control unit 22 recognizes a speed limit release sign and then recognizes and outputs a speed limit of a traffic sign positioned on a travel road on which the vehicle is traveling.

The electronic control unit 22 includes a reception unit 221, a combining unit 222, a determination unit 223, a speed limit determination unit 224, and an output support unit 225.

The reception unit 221 receives acquired road information from the camera 21. In addition, the reception unit 221 receives road information received from the navigation terminal 10. Here, the road information includes road attributes indicating, for example, a branch road, an intersection, a change road from an expressway to a national highway, a change road from a national highway to an expressway, and a road in a construction section. In addition, the reception unit 221 may receive the heading angle of the vehicle.

The combining unit 222 combines the road information of the camera 21 received from the reception unit 221 with the road information of the navigation terminal 10.

Through the combination of two road information items, the speed limit of a traffic sign may be recognized well even in a fluid situation on a road.

The determination unit 223 determines whether the travel road is a branch road, a road at an intersection, a change road from an expressway to a national highway, a change road from a national highway to an expressway, or a road in a construction section, based on the road attributes included in the road information received from the navigation terminal 10.

According to a result determined by the determination unit 223, when the travel road is determined as one of a ranch road, a road at an intersection, a change road from an expressway to a national highway, a change road from a national highway to an expressway, or a road in a construction section, the speed limit determination unit 224 recognizes and determines the speed limit of a traffic sign positioned on the determined traffic road.

Here, when the travel road is the branch road, the speed limit determination unit 224 defers outputting of the speed limit of the traffic sign recognized using the GPS information of the vehicle before the vehicle reaches the branched point, and when the travel road, on which the vehicle travels, is finally determined at the junction, the speed limit determination unit 224 recognizes and determines the speed limit of the determined travel road. The current GPS information of the vehicle is received through a GPS receiver (not illustrated) provided in the navigation terminal 10.

In addition, when the travel road is a road at an intersection, the speed limit determination unit 224 determines whether to travel straight, whether to turn left or whether to turn right based on a received heading angle of the vehicle or a heading angle determined based on the vehicle angle, and recognizes and determines the speed limit of a traffic sign positioned on a travel road in the determined direction. The vehicle information includes measurement values measured through various sensors installed in the vehicle during the operation of the vehicle.

When the travel road is a change road from an expressway to a national highway or from a national highway to an expressway, the speed limit determination unit 224 recognizes and determines the speed limit of a traffic sign positioned on the change road using the GPS information of the vehicle.

When the travel road is a road in a construction section, the speed limit determination unit 224 recognizes a speed limit release sign and then recognizes and determines the speed limit of a traffic sign positioned on the current travel road using the GPS information of the vehicle.

In this way, the speed limit determination unit 224 recognizes and determines the speed limit in the road information combined by the combining unit 222. Thus, recognition precision is high as compared to the recognition of the speed limit based on the road information acquired through the camera 21.

The output support unit 225 outputs the speed limit, which has been determined through the speed limit determination unit 224, through the cluster 23, through the speaker 24, or through the cluster 23 and the speaker 24. Thus, the driver is capable of correctly recognizing the speed limit of the travel road through the speed limit displayed on the cluster 23, the speed limit output through the speaker 24, or a combination thereof.

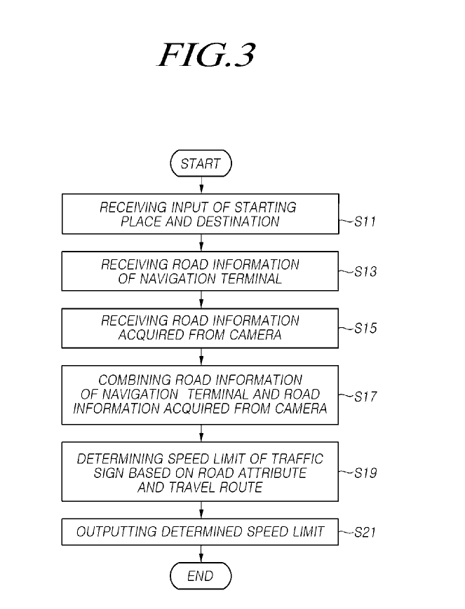

Now, descriptions will be made on a method of outputting a speed limit using the traffic sign recognition device configured as described above, with reference to FIG. 3.

FIG. 3 illustrates an operation flowchart for describing a method of outputting a speed limit using a traffic sign recognition device according to an embodiment of the present invention.

Referring to FIG. 3, the navigation terminal 10 receives an input of a starting place and a destination (S11). The navigation terminal 10 generates a travel route based on the input starting place and destination and displays the travel route on a screen.

The electronic control unit 22 receives road information on the generated travel route from the navigation terminal 10 (S13).

The electronic control unit 22 receives road information acquired through the camera 21 (S15). At this time, the camera 21 acquires a front image for a scene positioned in front of the vehicle. On the front image, for example, a speed limit indicated on the road and a speed limit indicated on a sign installed in the periphery of the road may be included in addition to lanes on the road.

The electronic control unit 22 combines the road information provided in step S13 described above with the road information acquired in step S15 (S17). Through this combination, a traffic sign may be precisely recognized from the road information concerning to the scene positioned in front of the vehicle.

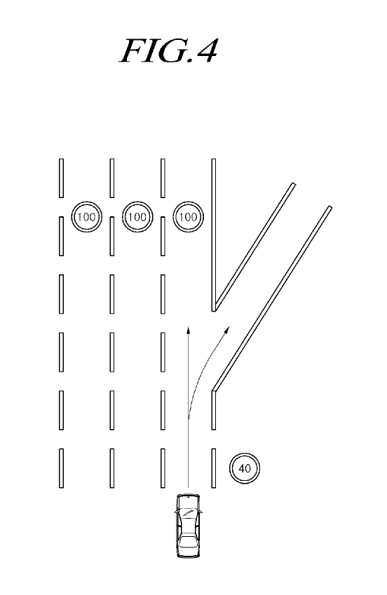

The electronic control unit 22 determines the speed limit of a traffic road determined based on the road attribute and the travel route included in the road information received from the navigation terminal 10 (S19). The road attribute may be any one of road environments as illustrated in FIGS. 4 to 7.

The electronic control unit 22 recognizes and extracts a traffic sign from the road information combined by the combining unit 222 and recognizes characters, numbers or a combination thereof in the extracted traffic sign.

The electronic control unit 22 outputs a speed limit determined based on the road attribute and the travel route (S21). The speed limit is output through the cluster 23, the speaker 24, or the cluster 23 and the speaker 24 to be delivered to the driver so that speeding can be prevented.

Referring to FIG. 4, when the road attribute included in the combined road information is a branch road, the electronic control unit 22 defers outputting the speed limit “40” of a traffic sign recognized before the vehicle reaches a junction, and receives GPS information of the vehicle. When the travel road, to which the vehicle is directed, is finally determined according to the received GPS information, the electronic control unit 22 outputs the speed limit of the corresponding travel road. That is, the electronic control unit 22 outputs the speed limit “100” of a traffic sign positioned on a road when the vehicle travels straight at a junction, thereby preventing a malfunction that outputs a speed limit which is not a speed limit in the travel direction of the vehicle but a speed limit before a branch load is branched at the place where a road, such as an advancing road or a high-level road, is branched, so that the newest information suitable for a travel environment cannot be deliver to the driver.

More specifically, a traffic sign, which is positioned before a junction in FIG. 4 and indicates a speed limit “40,” is a traffic sign that indicates a speed limit of a right turning road. When the speed limit “40” for the right turning road is indicated while the vehicle travels straight, the driver may fall into confusion. Thus, it is desirable that the speed limit recognized through the traffic sign should not be output.

For this purpose, the electronic control unit 22 defers outputting of the speed limit “'40” of the traffic sign which has been recognized before reaching the junction, and when the final travel road is determined at the junction, the electronic control unit 22 outputs the speed limit of the corresponding road.

At the junction, when it is determined that the travel road is the right turning road through GPS information, the electronic control unit 22 outputs the speed limit “40” indicated on the traffic sign that indicates the speed limit of the right turn load just before the junction, through the cluster or the speaker.

Whereas, at the junction, when it is determined that the travel road is a straight travel road through the GPS information, the electronic control unit 22 may disregard the speed limit “40” of the recognized traffic sign without outputting the speed limit.

At this time, the electronic control unit 22 may keep on outputting the speed limit recognized before recognizing the traffic sign without outputting the speed limit “'40” of the recognized traffic sign. For example, when “100” has been output as the speed limit before reaching the junction, the electronic control unit 22 may continuously output the speed limit “100” after it is determined that the travel road is the straight travel road after reaching the junction.

In addition, the electronic control unit 22 may output the speed limit acquired through the road information received from the navigation terminal without outputting the speed limit “40” of the recognized traffic sign.

Meanwhile, at the junction, the electronic control unit 22 may determine the travel road based on other determination factor.

As an example, when the vehicle reaches the junction in a state where the vehicle is not positioned on the outermost lane of the road (the right turn lane in FIG. 4—in this case, it may be determined that the travel load is the straight advancing road,—the electronic control unit 22 may not output the speed limit “40” of the traffic sign for the branch road.

As another example, when the electronic control unit 22 acquires a turn signal information but the turn signal does not indicate the direction of the branch road—in this case, it may be determined that the travel road is the straight advancing road,—the electronic control unit 22 may not output the speed limit “40” of the traffic sign.

Meanwhile, the traffic sign for a branch road (in FIG. 4, the sign indicating “40”) may separately include a branch indication. For example, a traffic sign for the right branch may further indicate an arrow in a right low portion thereof.

The electronic control unit 22 may further recognize the branch indication so as to determine whether the corresponding traffic sign is a traffic sign for a branch road or a traffic sign for a straight advancing road, and based on the determination, the electronic control unit 22 may or may not output the speed limit of the traffic for the branch road as described above.

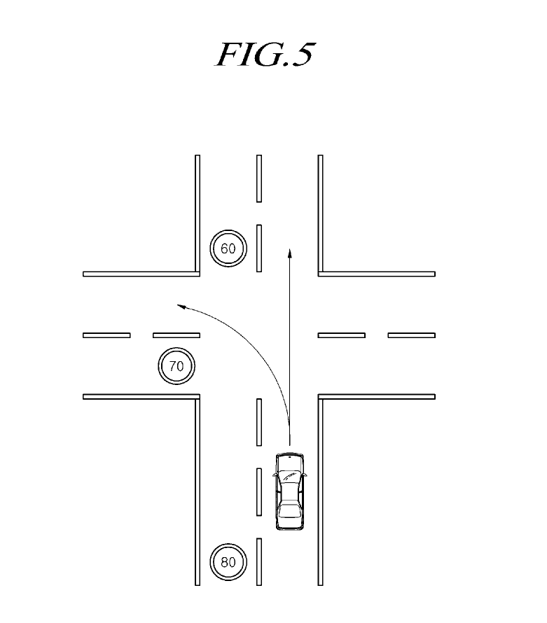

Referring to FIG. 5, when the road attribute included in the combined road information is a road at an intersection, the electronic control unit 22 confirms the heading angle of the vehicle at the time when a traffic sign disappears from an image. When it is determined that the travel road is a left turn among straight-advancing, left turn, and right turn, the electronic control unit 22 defers outputting of the speed limit “60” of the traffic sign in the straight advancing direction and outputs the speed limit “70” of the traffic sign in the left turn direction which corresponds to the travel road of the vehicle. Thus, at the time of the left turn travel at the intersection, the electronic control unit 22 may output the speed limit as “80”→“70” to output the speed limit of the traffic sign positioned in the same direction as the travel direction. Thus, a malfunction in the conventional traffic sign recognition device can be prevented. At the time of left turn travel, the conventional traffic sign recognition device outputs speed limits in the order of “80”→“60”→“70”, thereby causing a malfunction that outputs the speed limit of a traffic sign positioned in a direction which is not the travel direction.

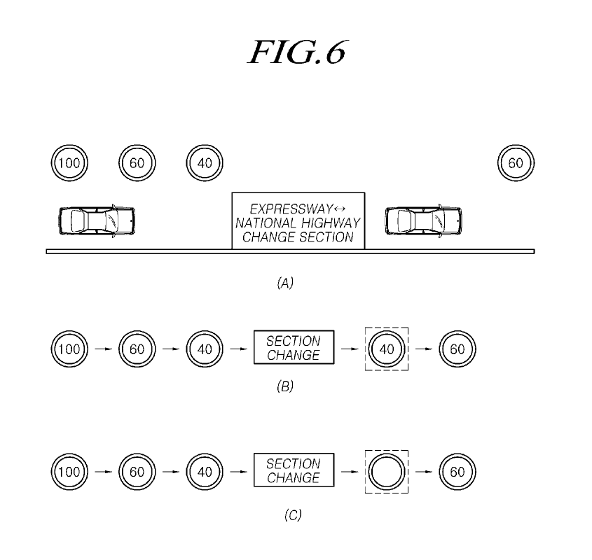

Referring to FIGS. 6a to 6c, when the road attitude included in the combined road information is a change road, as illustrated in FIG. 6a, the electronic control unit 22 deletes a speed limit “40” positioned on a road before change, and outputs a speed limit “60” positioned on a road after change. FIG. 6b illustrates an example, in which a conventional traffic sign recognition device notifies the driver of an incorrect speed limit by outputting a speed limit “40” of a traffic sign positioned on a load before change until a new traffic sign appears on a travel road after change, and FIG. 6c illustrates an example, in which a traffic sign recognition device according to an embodiment of the present invention deletes a speed limit of a traffic sign positioned on a road before change until a new traffic sign appears on a road after change, thereby preventing a malfunction that delivers the speed limit to the driver.

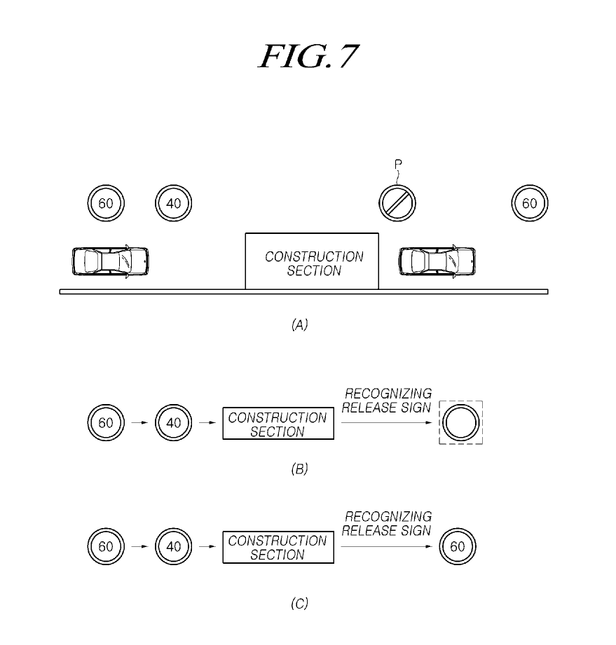

Referring to FIGS. 7a to 7c, when the road attribute included in the combined road information is a road in a construction section, as illustrated in FIG. 7a, the electronic control unit 22 recognizes a speed limit release sign P in the construction section and then outputs the speed limit “60” of a new traffic sign. FIG. 7b illustrates an example, in which a conventional traffic sign recognition device does not recognize a new speed limit sign after recognizing a speed limit release sign, and FIG. 7c illustrates an example, in which a traffic sign recognition device according to an embodiment of the present invention recognizes the speed limit of a new traffic sign after recognizing a speed limit in the construction section, thereby outputting the updated newest speed limit to the driver.

When the road attribute is a road in a construction section, the electronic control unit 22 outputs a speed limit of a traffic sign, which was recognized before entering the construction section, while the vehicle is passing the road in the construction section. In addition, when a speed limit release sign is recognized, the electronic control unit 22 may delete the speed limit output so as to pass through the road in the construction section, and output a speed limit of the road on which the vehicle is traveling.

At this time, as in FIG. 7b, when the electronic control unit 22 does not recognize a new speed limit sign after recognizing the speed limit release sign, the electronic control unit 22 may output a speed limit included in road information acquired from the navigation terminal.

Meanwhile, a plurality of traffic signs may be positioned on a road. At this time, the electronic control unit 22 may recognize respective speed limit values included in the plurality of traffic signs and output only one speed limit value among the recognized speed limit values.

For example, the electronic control unit 22 may photograph a plurality of cameras as one image through the camera, recognize a plurality of speed limit values through an analysis for the photographed image, and output only one speed limit value among the plurality of speed limits.

As a specific example, traffic signs, on which different speed limits are indicated, may be positioned on lanes, respectively. In such a case, the electronic control unit 22 may recognize a lane, on which the vehicle is traveling, and output only the speed limit value of the traffic sign positioned in front of the vehicle on the recognized lane.

Meanwhile, the traffic sign may be a sign, which is printed with a character, a number, or a figure, but is not limited thereto. For example, the traffic sign may be an electric sign constituted with a plurality of Light Emitting Diodes (LEDs).

When the traffic sign is constituted with a plurality of LEDs, the speed limit value indicated on the traffic sign may be frequently changed. The frequently changed speed limit value is not updated in the navigation terminal, which may cause an inconvenience to a driver who recognizes the speed limit through the navigation terminal.

Whereas, a traffic sign recognition device of an embodiment of the present invention is capable of recognizing a speed limit indicated on a traffic sign in real time through the camera, thereby providing more precise speed limit information to the driver.

As described above, the electronic control unit 22 outputs a speed limit of a traffic sign positioned on a travel road of a vehicle based on road information and a travel route so that a driver can precisely recognize a speed limit suitable for a travel environment.

The present invention is not limited to the embodiments described above. Various modifications and changes may be made to the present invention by a person ordinarily skilled in the art and the modifications and changes are included in the spirit and scope of the present invention defined in the accompanying claims.

What is claimed is:

1. A traffic sign recognition device comprising:
a navigation terminal configured to store a road attribute; and
an electronic control unit configured to recognize a speed limit indicated on a traffic sign positioned on a travel road, on which a vehicle is traveling, through a camera and control outputting of the speed limit according to the road attribute.

2. The traffic sign recognition device of claim 1, wherein the road attribute includes a branch road, a road at an intersection, a change road from an expressway to a national highway, a change road from a national highway to an expressway, or a road in a construction section.

3. The traffic sign recognition device of claim 1, wherein, when the road attribute received from the navigation terminal is a branch road, the electronic control unit defers outputting of a speed limit recognized through a traffic sign until the vehicle reaches a junction, determines the travel road of the vehicle, which is branched from the junction, using GPS information of the vehicle, and outputs a speed limit of a traffic sign positioned on the determined travel road.

4. The traffic sign recognition device of claim 1, wherein, when the road attribute is a branch road and a turn signal does not indicate a branch road direction, the electronic control unit does not output the speed limit recognized through the traffic sign.

5. The traffic sign recognition device of claim 1, wherein, when the road attribute received from the navigation terminal is a road at an intersection, the electronic control unit determines whether a travel road, on which the vehicle is to travel, is a straight-advancing road, a left turning road, or a right turning road according to a heading angle of the vehicle, and when the travel road is determined, the electronic control unit outputs a speed limit of a traffic sign positioned on the determined travel road.

6. The traffic sign recognition device of claim 1, wherein, when the road attribute received from the navigation terminal is a change road, the electronic control unit deletes a speed limit of a traffic sign recognized on the traffic road, on which the vehicle has traveled, and outputs a speed limit of a traffic sign recognized on a changed travel load, on which the vehicle is traveling.

7. The traffic sign recognition device of claim 1, wherein, when the road attribute received from the navigation terminal is a road in a construction section, the electronic control unit recognizes a speed limit release sign of the road in the construction section, and then recognizes and outputs a speed limit of a travel road, on which the vehicle is traveling.

8. The traffic sign recognition device of claim 1, wherein the electronic control unit photographs a plurality of traffic signs as one image through the camera, recognizes a plurality of speed limit values through an analysis for the one image, and outputs only one speed limit among the plurality of speed limit values.

9. The traffic sign recognition device of claim 8, wherein the electronic control unit recognizes a lane, on which a vehicle is traveling, and outputs only a speed limit value of a traffic sign positioned in front of the vehicle on the lane.

10. A method of outputting a speed limit using a traffic sign recognition device which acquires and outputs a speed limit of a traffic sign on a road through a camera, the method comprising:
combining road information received from a navigation terminal and road information acquired through the camera; and
determining a travel road based on a road attribute and a travel route included in the road information received from the navigation terminal, and recognizing and outputting a speed limit of the determined travel road from the combined road information.

11. The method of claim 10, further comprising:
generating and displaying the travel route by designating a starting place and a destination,
wherein the road information received from the navigation terminal is road information on the travel route.

12. The method of claim 10, wherein, when the road attribute received from the navigation terminal is a branch road, the outputting of a speed limit recognized through a traffic sign is deferred until the vehicle reaches a junction, the travel road of the vehicle, which is branched from the junction, is determined using GPS information of the vehicle, and a speed limit of a traffic sign positioned on the determined travel road is output.

13. The method of claim 10, wherein, when the road attribute received from the navigation terminal is a road at an intersection, it is determined whether a travel road, on which the vehicle is to travel, is a straight-advancing road, a left turning road, or a right turning road according to a heading angle of the vehicle, and when the travel road is determined, a speed limit of a traffic sign positioned on the determined travel road is output.

14. The method of claim 10, wherein, when the road attribute received from the navigation terminal is a change road, a speed limit of a traffic sign recognized on the traffic road, on which the vehicle has traveled, is deleted and a speed limit of a traffic sign recognized on a changed travel load, on which the vehicle is traveling, is output.

15. The method of claim 10, wherein, when the road attribute received from the navigation terminal is a road in a construction section, a speed limit release sign of the road in the construction section is recognized, and then, a speed limit of a travel road, on which a vehicle is traveling, is recognized and output.
